(19) United States
(12) Patent Application Publication
(10) Pub. No.: US 2003/0135851 A1
(43) Pub. Date: Jul. 17, 2003

(54) Method and system for concentration of applications during installation in target devices

(76) Inventors: Laura Dickey, Westford, MA (US); Vaideswar Gopalakrishnan, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/053,463

(22) Filed: Jan. 17, 2002

(51) Int. Cl. G06F 9/44; G06F 9/445

(52) U.S. Cl. 717/168; 717/174

(57) ABSTRACT

A method of installing an application on a target electronic device comprises receiving the application in the target device in unconcentrated form, concentrating the application in the target device, and installing the concentrated application in non-volatile memory of the target device. This method may be performed, for example, by an installer program stored on a medium for storing computer-readable instructions. The installer program, when executed, causes a host device to concentrate an unconcentrated application and install the concentrated application in non-volatile memory of the host device.

### FIELD OF THE INVENTION

The present invention relates to the field of electronic devices, particularly portable electronic devices. More specifically, the present invention relates to methods and systems for concentrating applications during installation in target devices.

### BACKGROUND OF THE INVENTION

Electronic devices provide users with an incredible range of functions and features. For example, personal digital assistants (PDAs) allow users to track information, record appointments, process text, play games, etc., with complete portability. Wireless phones allow users to make and receive phone calls from any location within a service area. Set-top boxes allow users to connect to satellite and cable television systems to receive and record hundreds of channels of television programming. Printers allow users to create hardcopy documents from electronic files.

These and other electronic devices are constantly evolving to offer more and more services to users. One particular way of enhancing the functionality of any such device is through a connection, wired or wireless, to the Internet or World Wide Web (the Web). With the information available on or through the Web, the functionality and features of almost any electronic device can be enhanced.

For example, the JAVA programming language is frequently used to write programs or applications for mobile devices. The JAVA programming language is particularly popular for Web-based applications or applications that interface with the Web.

The sizeable memory requirements of JAVA applications, i.e., the memory footprint required to store and execute a JAVA application, has been a significant obstacle that has prevented smaller electronic devices from being interfaced with the Web. When electronic devices are mass-produced, the cost of incremental amounts of memory greatly impacts the cost of the device. Moreover, if a device is portable and battery-operated, the amount of memory required during operation impacts the power usage and, hence, the convenience of owning and using the device. Consequently, device manufacturers have avoided offering features and functionality, such as the e-services that would be available to many devices if provided with a Web connection, due to the demands that such functionality would place on limited device memory, and the impact such demands would have on device cost, size or operability.

### SUMMARY OF THE INVENTION

There is a need in the art for means and methods of decreasing or minimizing the memory requirements of applications in mass-produced and portable electronic devices so that such devices can be more readily interfaced with the Web to increase or enhance services to users.

Consequently, the present invention provides, among other things, a method of installing an application on a target electronic device by receiving the application in memory of the target device in unconcentrated form, concentrating the application in the target device, and installing the application in concentrated form in non-volatile memory of the target device.

Another aspect of the present invention encompasses an installer program stored on a medium for storing computer-readable instructions. The installer program, when executed, causes a host device to concentrate an unconcentrated application stored on the host device; and install the application in concentrated form in non-volatile memory of the host device.

A further embodiment within the teachings of the present invention encompasses an electronic device that hosts applications, the device comprising volatile memory, non-volatile memory, and an installer program configured to concentrate an application in the target device and install the application in concentrated form in the nonvolatile memory of the device.

### BRIEF DESCRIPTION OF THE DRAWINGS

The accompanying drawings illustrate preferred embodiments of the present invention and are a part of the specification. Together with the following description, the drawings demonstrate and explain the principles of the present invention. The illustrated embodiments are examples of the present invention and do not limit the scope of the invention.

FIG. 1 is a block diagram illustrating the receipt of an unconcentrated application in a target electronic device over a wired network according to the principles of the present invention.

FIG. 2 is a block diagram illustrating the receipt of an unconcentrated application in a target electronic device over a wireless network according to the principles of the present invention.

FIG. 3 is a block diagram illustrating an example of concentration during installation of the unconcentrated application according to the principles of the present invention.

FIG. 4 is flow chart illustrating a method of installing a concentrated application according to the present invention.

FIG. 5 is block diagram illustrating the receipt and concentration during installation of an application provided in non-volatile memory or on a removable storage device.

FIG. 6 is a flowchart illustrating another method of installing and concentrating an application according to the present invention.

FIG. 7 is a block diagram illustrating the execution of an application installed in concentrated form according to the present invention.

Throughout the drawings, identical elements are designated by identical reference numbers.

### DETAILED DESCRIPTION OF THE PREFERRED EMBODIMENTS

The present invention provides a method for concentrating an application during installation of the application in a target electronic device. The unconcentrated application is received in a regular or a standard format. The unconcentrated application is held in volatile memory while an installer program or Application Management System reads the application into non-volatile memory for long-term storage. As the installer program reads the application into non-volatile memory, i.e., installs the application, the installer program also performs a series of algorithms on the application to concentrate the application so that the application as installed in non-volatile memory requires far less memory than would be the case if the application were not concentrated. Further, the concentrated application can be loaded from non-volatile memory and executed in its concentrated form by an appropriately configured virtual machine thereby minimizing the volatile memory required for running the application.

A virtual machine (VM) is a self-contained operating environment that runs on a computer or processor but behaves as if it were a separate computer or processor within the host device. An advantage of virtual machines is that an application designed for that virtual machine will run the same in any host device running that virtual machine regardless of the hardware and software (i.e., the operating system) of the host device. Additionally, a virtual machine can be configured to accept and run an application that has been concentrated according to a particular concentration scheme.

A concentration scheme is a set of algorithms that can be used to reduce the size of an application by, for example 50% or more. A concentrated application requires less memory for long-term storage. Additionally, as indicated above, an application can be executed in concentrated form by a virtual machine appropriately designed to execute applications concentrated according to a particular concentration scheme.

One example of such technology is the Chai® virtual machine currently available from Hewlett-Packard Company. The Chai® virtual machine employs Chai® Freezedry™ technology which is an application concentration scheme. The Chai® Freezedry™ technology is disclosed and claimed in U.S. Pat. No. 6,163,780 to Ross, entitled “System and Apparatus for Condensing Executable Computer Software Code,” incorporated herein by reference in its entirety.

Recently, concentration technology, including, for example, the Chai® platform, has been scaled to meet the needs of a broad range of mobile and other high-volume consumer devices, particularly where power and memory resources are at a premium. The MicroChai™ VM, which also employs the Freezedry™ algorithms, is one example of a platform for concentrated applications in, for example, mobile devices.

With a concentration scheme, such as the Freezedry™ technology, concentration of an application can be effected in several ways. For example, at runtime, when an application is being loaded from non-volatile memory to volatile memory, e.g., Random Access Memory (RAM), for execution, a concentrating loader can dynamically concentrate the application as it is read into RAM. As a result, the application requires far less RAM than it would in unconcentrated form. Consequently, the host device need not have as much RAM to run the application and will require less power to operate. These are tremendous advantages, particularly in small, mobile devices that are battery-powered.

Alternatively, a concentration developer tool can concentrate an application before it is installed into the host device. Consequently, the application is stored in concentrated form and requires less non-volatile memory. When the application is loaded to RAM for execution, the application remains concentrated and thus requires less RAM.

However, users may frequently wish to directly download applications that are in a standard, unconcentrated form to host devices and will not likely have the means to concentrate the application before installing it on the host device. Users may also not be able to get an application in concentrated form for installation. In order to ensure compatibility or compliance with various specifications, vendors typically prefer, or may be required, to provide applications in a standard format that is unconcentrated.

In standard format, typically the classes in an application must be represented in a standard classfile format. All classes for an application are packaged together in a single file known as a “jar” file, which stores multiple files in a compressed form. There is also a descriptor file known as a “jad” file, which gives the VM additional information about the contents of the corresponding jar file.

Standards for configurations and profiles, both present and future, will largely define how applications are written for various types of host devices. For example, the Mobile Information Device Profile (MIDP) is a standard profile compliant with the JAVA 2 Platform Micro Edition (J2ME) for use in wireless phones and two-way pagers. Vendors produce applications that enhance the features or functionality of a target host device according to the appropriate standard formats for that target host device and distribute the applications in the standard format.

Consequently, the present invention provides a means and method of concentrating an application during installation so that, even if the application is received in unconcentrated form, all the advantages of storing and executing the application in concentrated form are realized. This additionally enables vendors or service providers to provide applications in standard format without concern as to whether a customer will use the application in concentrated form or what type of concentration scheme may be used on the application.

There are advantages to storing or installing the application in concentrated form. The amount of non-volatile memory required to store the application is reduced. Additionally, because the application is stored in a concentrated form, it does not have to be concentrated as it is loaded and executed in order to minimize the RAM necessary to run the application. Thus, storing or installing an application in concentrated form allows the host device to use less non-volatile memory, volatile memory and power to support use of the application.

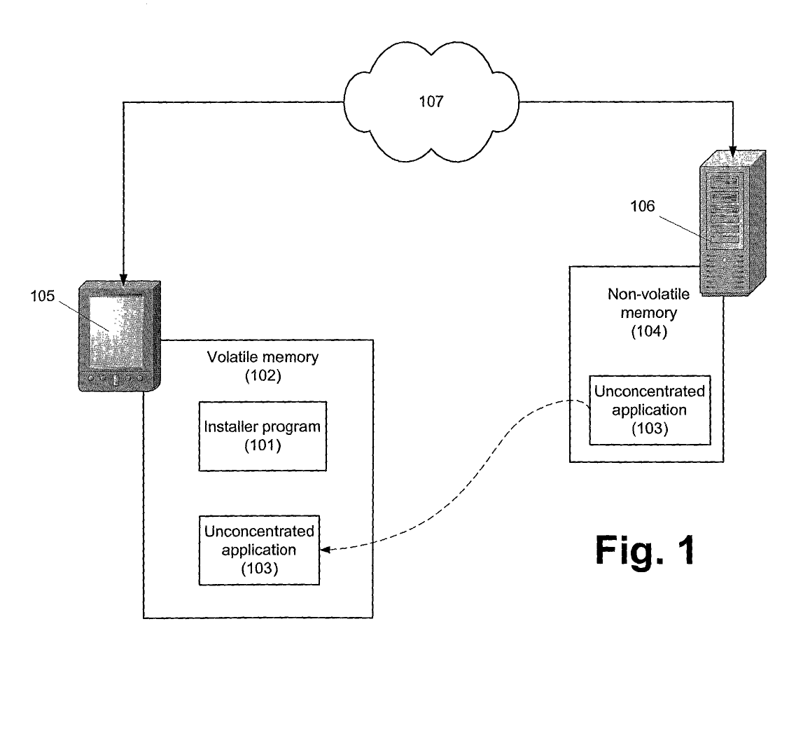

FIG. 1 is a block diagram illustrating the receipt of an unconcentrated application in a target electronic device over a wired network for purposes of explaining principles of the present invention. As shown in FIG. 1, the target electronic device (105) may be a personal digital assistant. However, the target device can be any device that runs applications, e.g., embedded applications, firmware, software, etc., for example a wireless phone, two-way pager, set-top box, printer, multi-function peripheral, etc. The target device may also be referred to as a host device.

As shown in FIG. 1, the target device (105) is connected to a network (107). The network (107) may be the Internet, a local area network (LAN), wide area network (WAN), etc. Through the network (107), the target device (105) is connected to a remote server (106) from which an application will be provided for use on the target device (105).

The target device (105) includes volatile memory (102), e.g., RAM, in which applications are stored for execution or during installation. An installer program (101), also referenced herein as an Application Management System, can be resident in the volatile memory (102) and running on the target device (105). The installer program (101) will be explained below in detail.

The remote server (106) includes non-volatile memory (104). This nonvolatile memory (104) may be, for example, a hard drive. Alternatively, the non-volatile memory (104) may be a removable storage device such as a floppy disc or an optical disc. The non-volatile memory (104) is not limited to any particular form and may be any data storage device now known or later developed. An unconcentrated application (103) resides in the non-volatile memory (104) of the remote server (106).

As shown in FIG. 1, the unconcentrated application (103) is downloaded via the network (107) to the volatile memory (102) of the target device (105). The application (103) is provided to the target device (105) for installation on the target device (105). This installation, including concurrent concentration of the application (103) will be explained below.

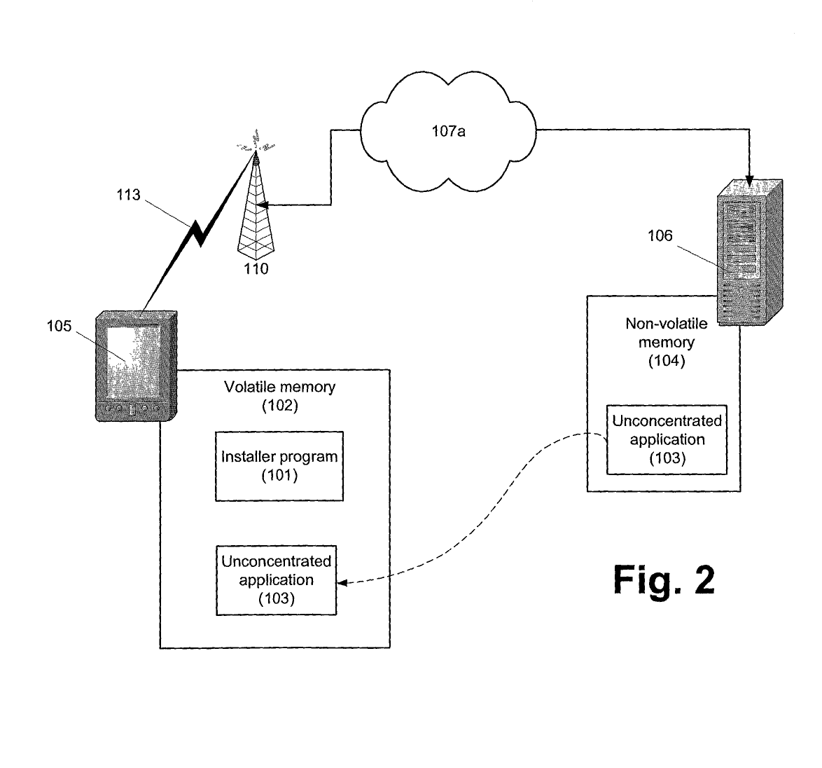

FIG. 2 is similar to FIG. I in that FIG. 2 is a block diagram illustrating receipt of an unconcentrated application in a target electronic device. However, FIG. 2 illustrates that the network (107a) over which the unconcentrated application (103) is delivered to the target device (105) may be an all or partially wireless network under the principles of the present invention.

For example, if the target device (105) is a personal digital assistant with wireless communication capability, or is a wireless phone or two-way pager, the target device (105) will wirelessly communicate with a base station (110) that is part of the network (107a) between the target device (105) and the remote server (106). The radio frequency signal (113) between the target device (105) and the base station (110) of the network (107a) can be used to transmit the unconcentrated application (103) to the target device (105).

Alternatively, the target device (105) and server (106) may each have an optical or infrared transceiver. The target device (105) can then be brought to the server (106) and the unconcentrated application (103) can be downloaded to the target device (105) over a wireless optical link between the transceivers. Alternatively, any other communication mechanism, now known or later developed, can be used to transmit the unconcentrated application (103) to the target device (105).

Within the principles of the present invention, the unconcentrated application (103) can be transferred to the target device (105) by any transmission method, now known or later developed. The unconcentrated application (103) is received and held in volatile memory (102) under the control of the installer program (101) running on the target device (105). There, the application (103) awaits installation and concentration by the installer program (101).

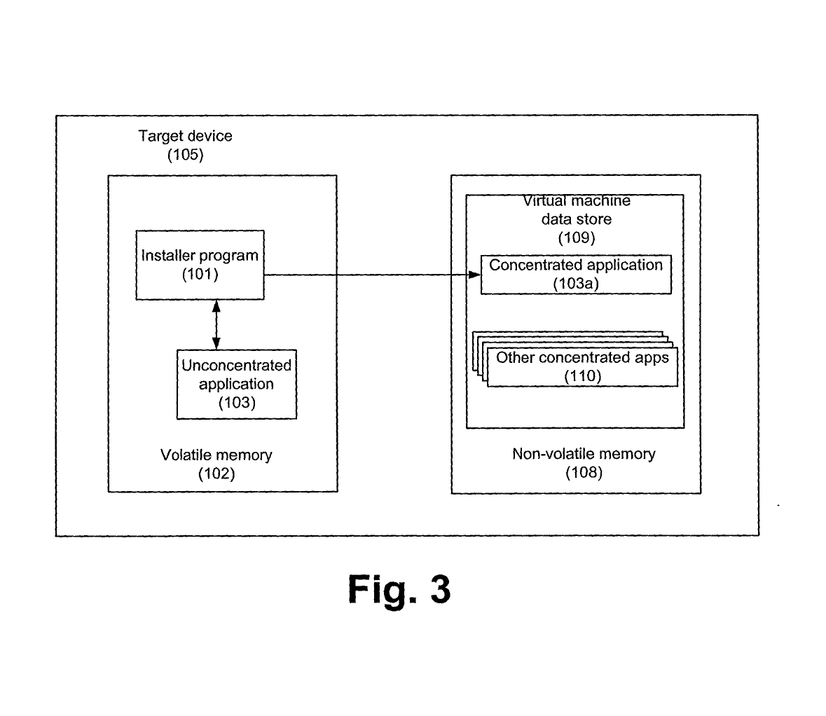

FIG. 3 is a block diagram illustrating an example of concentration during installation of the unconcentrated application according to the principles of the present invention. As shown in FIG. 3, the target device (105) also includes non-volatile memory (108). The non-volatile memory (108) is where installed applications are stored long-term and from where installed applications are loaded into volatile memory (102), e.g., RAM, for execution.

After an unconcentrated application (103) is received in volatile memory (102) and is awaiting installation, as shown in FIG. 3, the installer program (101) will install the application (103). The installation involves two concurrent functions. The installer program (101) will concentrate the unconcentrated application (103). This concentration is preferably performed using the algorithms disclosed, for example, in commonly-assigned U.S. Pat. No. 6,163,780 which has been incorporated herein in its entirety.

As the application is concentrated, the installer program (101) transfers and stores the concentrated application (103a) in the non-volatile memory (108) of the target device (105). In particular, the concentrated application (103a) may be stored in a portion of non-volatile memory (108) dedicated to the virtual machine that will run the application (103a). This portion of memory (108) is preferably a virtual machine data store (112). Other concentrated applications (111) may also reside in the virtual machine data store (109).

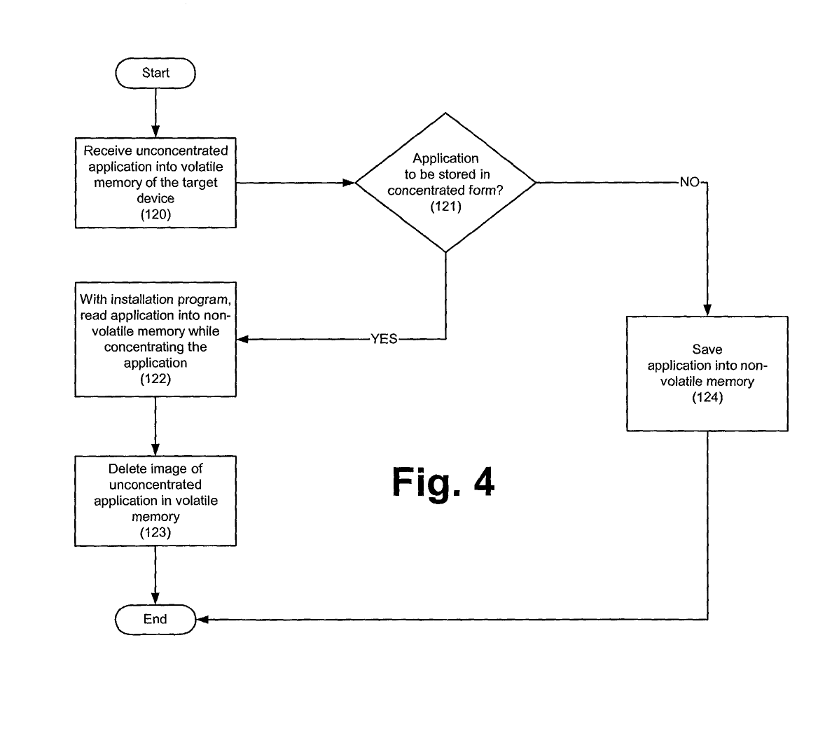

FIG. 4 is flow chart illustrating a method of installing a concentrated application according to the present invention. This flow chart also serves as an outline and disclosure of an installer program according to the teachings of the present invention and may be used by one of skill in the art to create an installer program according to the present invention. Such an installer program consists of computer-readable instructions stored on a medium for storing computer-readable instructions, such as a hard drive, optical disc, floppy disc, semiconductor memory, or any other such medium now known or later developed.

As shown in FIG. 4, the method begins when an unconcentrated application is received into the volatile memory of the target device (step 120). The application may or may not be intended for installation in concentrated form (determination 121). The target device may, through a user interface, enable a user to specify whether the application is to be concentrated when installed.

If the application is not to be saved in concentrated form, installation proceeds without concentration. The application is simply saved or installed into non-volatile memory (step 124).

If the application is to be installed in concentrated form (determination 121), the installation program reads the application and executes concentration algorithms on the application (step 122). As indicated above, the concentration algorithms used are preferably the algorithms disclosed in U.S. Pat. No. 6,163,780. As the application is concentrated, it is also saved to or installed in the non-volatile memory (step 122).

With the application installed in concentrated form in non-volatile memory, the application requires less non-volatile memory space and can be more quickly loaded into volatile memory for execution. After the application is concentrated and installed, the unconcentrated image of the application in volatile memory may be erased (step 123).

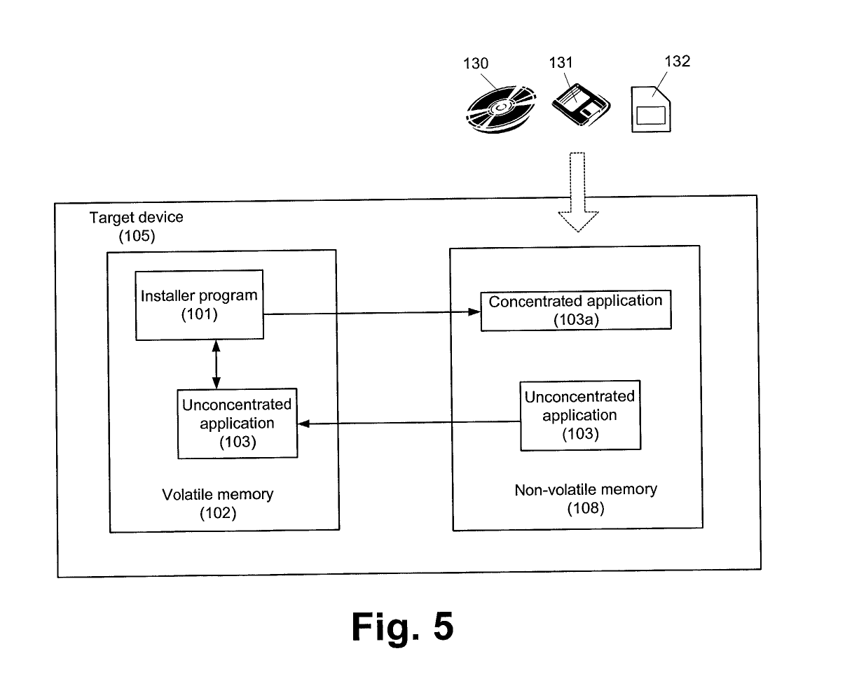

FIG. 5 is block diagram illustrating the receipt and concentration during installation of an application provided to the non-volatile memory of a target device (105) or on a removable storage device (e.g., 130, 131 or 132). As noted above, the principles of the present invention may be applied regardless of how the unconcentrated application to be installed is conveyed to the target device (105).

As shown in FIG. 5, the unconcentrated application (103) may be resident in the non-volatile memory (108) of the target device (105). This non-volatile memory (108) may be removable non-volatile data storage device such as, an optical disc (130), a floppy disc (131) or a FLASH memory chip or card (132). In any event, the unconcentrated application (103) is resident in non-volatile memory (108) that is in or accessible to the target device (105), whether or not the target device (105) is connected to any network or has any wireless communication capability. The unconcentrated application (103) is then loaded from non-volatile memory (108) into volatile memory (102). This may be performed by the installer program (101), either automatically or under the control of a user operating a user interface (not shown).

Once the unconcentrated application (103) is loaded into volatile memory (102) from non-volatile memory (108), the installer program (101) essentially operates in the same manner described above. The installer program (101) reads the unconcentrated application, dynamically concentrates the application and stores or installs a concentrated version of the application (103a) in the non-volatile memory (108) of the device (105).

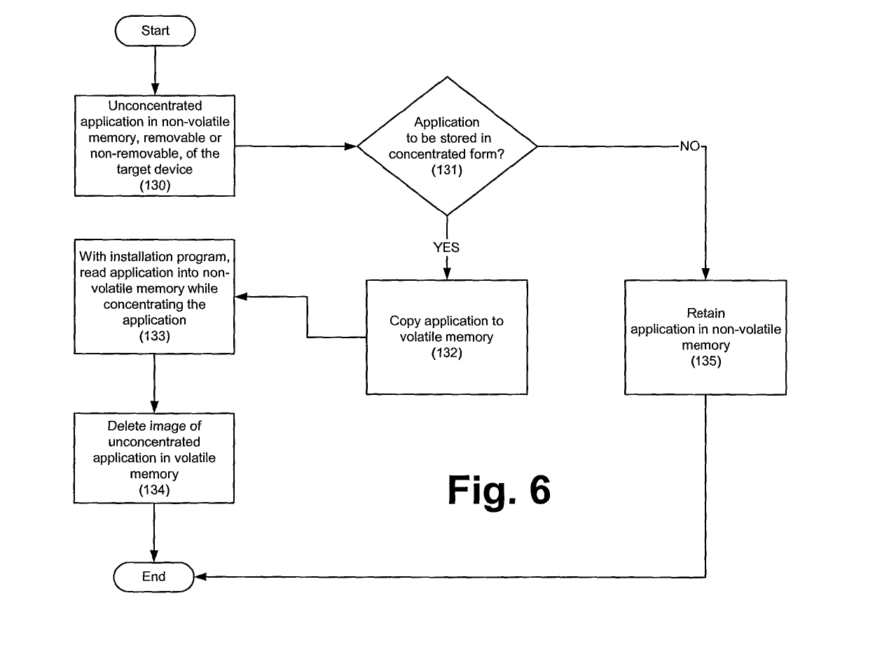

FIG. 6 is a flowchart illustrating a method of installing and concentrating an application according to principles of the present invention. This flow chart also serves as an outline and disclosure of an installer program according to the present invention and may be used by one of skill in the art to create such an installer program according to the present invention.

As shown in FIG. 6, the method begins when an unconcentrated application is resident in the non-volatile memory of the target device (step 130). The application may or may not be intended for installation in concentrated form (determination 131). The target device may, through a user interface, enable a user to specify whether the application is to be concentrated. This will allow the user to optimize the installation of the application based on available memory space. If the application is not to be installed in concentrated form, the application is retained in non-volatile memory in its unconcentrated form (step 135).

If, however, the application is to be installed or re-installed in concentrated form, the application is copied into volatile memory (step 132). The installation program then reads the application and executes concentration algorithms on the application (step 133). As indicated above, the concentration algorithms used are preferably the algorithms disclosed in U.S. Pat. No. 6,163,780. As the application is concentrated, it is also saved to, installed or re-installed in the non-volatile memory (step 133).

With the application installed in concentrated form in non-volatile memory, the application requires less non-volatile memory space and can be more quickly loaded into volatile memory for execution. After the application is concentrated and installed, the unconcentrated image of the application in volatile memory may be erased (step 134). The unconcentrated image of the application in non-volatile memory is preferably also erased.

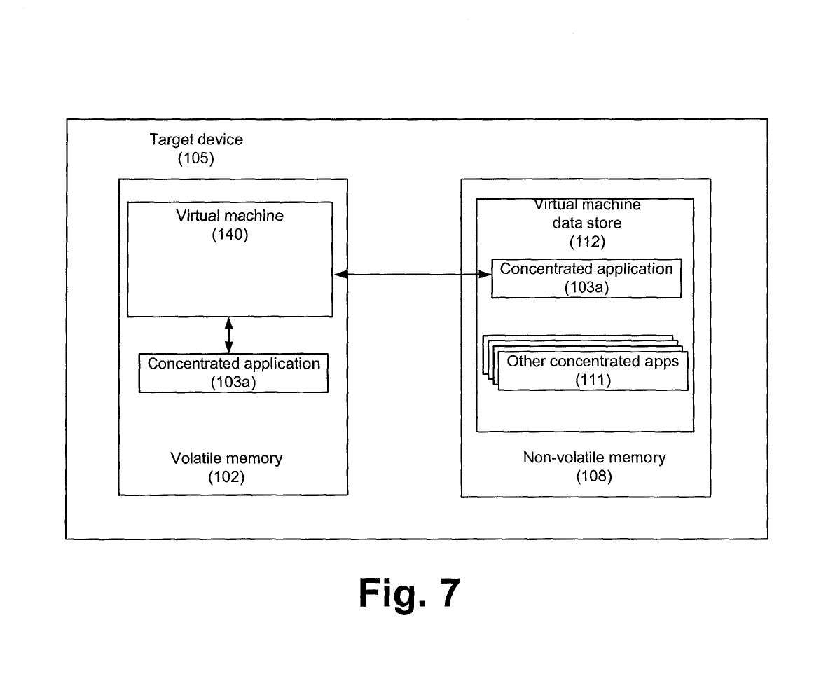

FIG. 7 is a block diagram illustrating the execution of an application installed in concentrated form according to the present invention. As shown in FIG. 7, the target device (105), in order to use an installed concentrated application (103a), begins by executing a virtual machine (140) that has been loaded into volatile memory (102). The virtual machine (140) loads the concentrated application (103a) from the virtual machine data store (112) of the non-volatile memory (108) into the volatile memory (102). The concentrated application (103a) can then be executed in the operating environment created by the virtual machine (140). The virtual machine (140) maybe compatible with the concentration scheme used to concentrate the application (103a).

What is claimed is:

1. A method of installing an application on a target electronic device, said method comprising:
receiving said application in said target device in unconcentrated form;
concentrating said application in said target device; and
installing said concentrated application in non-volatile memory of said target device.

2. The method of claim 1, wherein said concentrating and installing of said application are contemporaneously performed.

3. The method of claim 1, further comprising receiving said application via a network with which said target device is communicating.

4. The method of claim 1, further comprising copying said application from nonvolatile memory of said target device to volatile memory of said target device prior to said concentrating of said application.

5. The method of claim 1, further comprising copying said application from a non-volatile removable data storage device to volatile memory of said target device prior to said concentrating of said application.

6. The method of claim 1, wherein said installing of said application further comprises storing said application in concentrated form in a virtual machine data store.

7. The method of claim 1, further comprising executing said application in concentrated form with a virtual machine running on said target device.

8. The method of claim 1, further comprising executing said concentrated application prior to said step of installing.

9. An installer program stored on a medium for storing computer-readable instructions, said installer program, when executed, causing a host device to:
concentrate an unconcentrated application; and
install said concentrated application in non-volatile memory of said host device.

10. The program of claim 9, said program, when executed, further causing said host device to contemporaneously concentrate and install said application.

11. The program of claim 9, said program, when executed, further causing said host device to receive said application via a network with which said host device is communicating and store said application in volatile memory of said host device.

12. The program of claim 9, said program, when executed, further causing said host device to copy said application from non-volatile memory of said host device to volatile memory of said host device prior to concentrating said application.

13. The program of claim 9, said program, when executed, further causing said host device to copy said application from a non-volatile removable data storage device to volatile memory of said host device prior to concentrating said application.

14. The program of claim 9, said program, when executed, further causing said host device to install said application in concentrated form in a virtual machine data store.

15. A system for installing an application on a target electronic device, said system comprising:
means for concentrating said application in said target device; and
means for installing said concentrated application in non-volatile memory of said target device.

16. The system of claim 15, wherein said means for concentrating and said means for installing contemporaneously operate.

17. The system of claim 15, further comprising means for copying said application from non-volatile memory of said target device to volatile memory of said target device prior to concentrating said application.

18. The system of claim 15, further comprising means for executing said application in concentrated form.

19. The system of claim 18, wherein said means for executing said application in concentrated form comprise a virtual machine running on said target device.

20. An electronic device that hosts applications, said device comprising:
non-volatile memory; and
an installer program configured to concentrate an application in said target device and install said application in concentrated form in said non-volatile memory of said device.

21. The device of claim 20, further comprising a virtual machine stored in said non-volatile memory, said virtual machine being configured to execute concentrated applications when said virtual machine is executed.

22. The device of claim 20, further comprising a virtual machine data store within said non-volatile memory, said concentrated application being stored in said virtual machine data store.

23. The device of claim 22, further comprising a plurality of concentrated applications stored in said virtual machine data store.
